(19) United States
(12) Patent Application Publication
(10) Pub. No.: US 2003/0029387 A1
(43) Pub. Date: Feb. 13, 2003

(54) Kitty line and ball

(76) Inventor: Leo G. Callahan, Corner Brook (CA)

Correspondence Address: Leo G. Callahan, 92 Caribou Road, Corner Brook, NF, A2H 4X4, CA

(21) Appl. No.: 09/923,310

(22) Filed: Aug. 7, 2001

(51) Int. Cl. A01K 29/00

(52) U.S. Cl. 119/708

(57) ABSTRACT

Kitty's Line and Ball invention. Kitty's Toy made from deep sea fishing line. It has a handle, or wand for easy movement for young or old users. The Ball is made from sponge and crumrubber. The Ball is one and one-half inches (1½″) round or three and one-half centimeters (3½ cm) round. The Hole in the center is for the line to pass through. There are two (2) plastic washers before and after the line enters the ball. A five-inch (5″) strip of leather is tied in the center of the tailpiece to finish the assembly of the line ball. This strip is tied in the center of the tailpiece with a knot; leather is used for kitty to play with. There are two (2) knots before and after the beads, which are used for guide beads made from wood and glass at the end of the tailpiece. A wooden bead three-quarters (¾″) round is used as a weight to roll the ball forward and backward across a flat surface. This is a glass bead before and after the three-quarter (¾″) inch wooden bead. The woven braded line controls the ball. The woven line helps to turn the ball across the floor or flat surface. The Woven line is three and one-half centimeters (3 ½ cm) or one and one-half inches (1½″) long tied in the center of the ball, by a loop at the end of the hand line. The tailpiece passes through the ball and is tied in the center to the woven line part, of hand line piece. There is a rattle placed at the end of the tailpiece, inside a plastic tube, one and one-half inches long (1½″) or three and one-half centimeters (3½ cm). The two (2) ends meet and tied in the center of the ball.

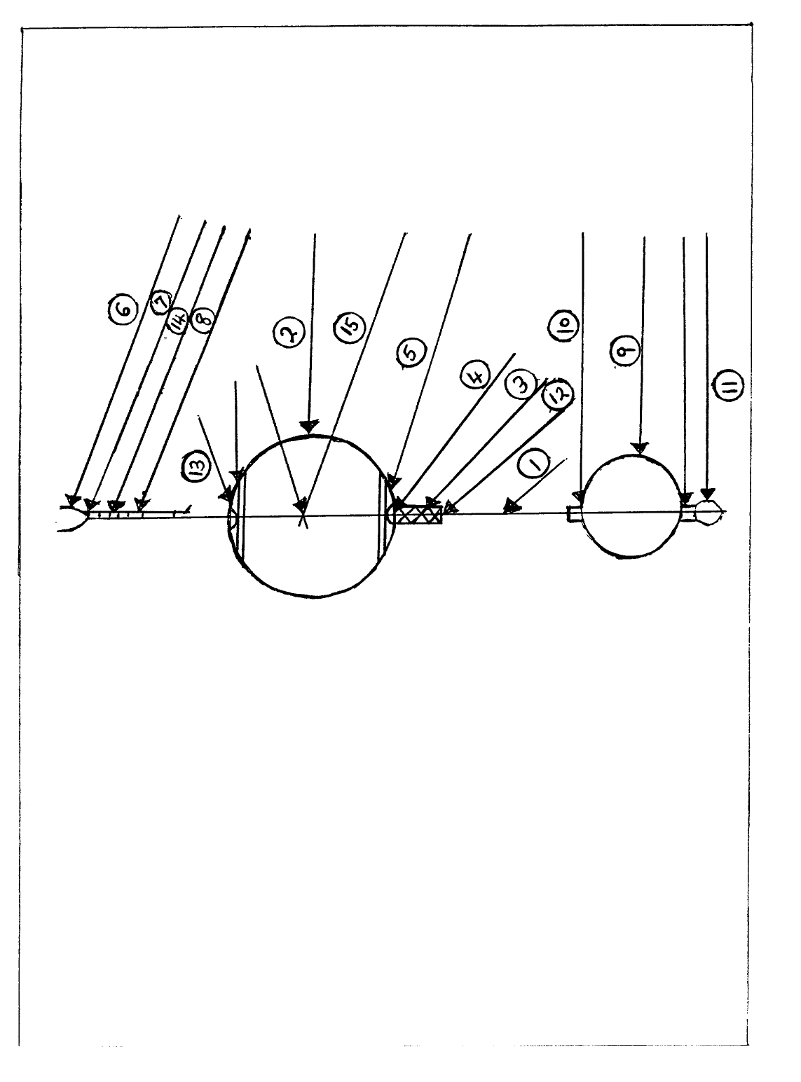

1. Solid braided nylon cord, Ashaway tuna leader line, and 150 lb. test color—blue. There is a wand or handle placed twelve inches (12″) from the start of the line, this wand is made from plastic tube, four inches (4″) in length.

2. Sponge ball is made from crumrubber and sponge.

3. Woven braided, with loop at one end passes through ball and is tied at center to the tailpiece.

4. Hole in the center of the ball for line to pass through.

5. There are (2) plastic washers at the beginning of the holes of the ball, to prevent the string form pulling though when being used.

6. Five (5″) inch strip of leather tied in the center of tailpiece.

7. This strip of leather is tied in the center of the tailpiece by a knot.

8. There are two (2) knots before and after the wood and glass guide beads at the end of the tailpiece.

9. A wooden three-quarter (¾″) inch round bead is used as weight to roll the ball forward and backward across a flat surface.

10. There is a glass bead before and after the three-quarter (¾″) inch bead.

11. Glass or wood bead at the start of the line.

12. Woven braided line controls the ball, woven line helps to turn the ball across a flat surface, woven line three and one-half centimeters (3½ cm) or one and one-half (1½″) inches long, next to the ball.

13. The tailpiece passes through the ball and ties in the center to woven line part or hand line piece.

14. There is a rattle at the end of the tailpiece.

15. The two (2) ends meet and are tied in the center of the ball.

### The embodiment of the invention is which an exclusive property or privilege is claimed is defined as follows:

1. A manually operable kitty's line and ball toy that moves in either direction across a flat surface, comprised of a sponge ball, perforated through the center, a solid braided 150 lb. test nylon cord that can be passed through and secured in the center of the sponge ball, a heavy ¾ inch wooden bead, a one inch plastic tube rattle adjacent to a five inch supple leather strip, and a glass and wooden guide beads.
